(19) United States
(12) Patent Application Publication
(10) Pub. No.: US 2025/0385440 A1
(43) Pub. Date: Dec. 18, 2025

(54) MULTI-ANTENNA SYSTEM WITH SLOTTED ANTENNA ELEMENTS AND EXTENDED GROUND PLANE

(71) Applicant: TAOGLAS GROUP HOLDINGS LIMITED, Enniscorthy, County Wexord (IE)

(72) Inventors: Milad Mirzaee, Minneapolis, MN (US); Gregory Jay Samson, Minneapolis, MN (US); Zaaminali Walji, Minneapolis, MN (US); Patrick Carl Frank, Minneapolis, MN (US)

(21) Appl. No.: 19/228,508

(22) Filed: Jun. 4, 2025

Related U.S. Application Data
(60) Provisional application No. 63/660,201, filed on Jun. 14, 2024.

(51) Int. Cl. H01Q 21/06; H01Q 1/42; H01Q 21/00

(52) U.S. Cl. CPC H01Q 21/064; H01Q 1/427; H01Q 21/0043

(57) ABSTRACT

Multi-antenna system with slotted antenna elements and an extended ground plane. In one embodiment, the multi-antenna system includes a flexible substrate having: a coplanar extended ground plane; a first slotted antenna element having a first feed structure connected with a first coplanar wave guide, the first feed structure being surrounded by the coplanar extended ground plane; and a second slotted antenna element comprising a second feed structure connected with a second coplanar wave guide, the second feed structure being surrounded by the coplanar extended ground plane. In a variant, the flexible substrate includes an isolation enhancing slot that is positioned between portions of the first slotted antenna element and portions of the second slotted antenna element.

### CROSS-REFERENCE TO RELATED APPLICATIONS

This application claims the benefit of priority to co-owned and co-pending U.S. Provisional Patent Application Ser. No. 63/660,201 filed Jun. 14, 2024, of the same title, the contents of which being incorporated herein by reference in its entirety.

### TECHNOLOGICAL FIELD

The present disclosure relates generally to multi-antenna systems, and more particularly in one exemplary aspect to multi-antenna systems that include two or more slotted antenna elements with an extended ground plane.

### FIELD OF THE DISCLOSURE

Traditionally, antennas and multi-antenna systems for use with, for example, recreational vehicles (RVs), possess undesirable aesthetics and form factors. These undesirable aesthetics and form factors were driven in large part by the need to maintain sufficient electrical performance between each of the individual antenna elements within these multi-antenna designs. More recently, a flexible printed circuit board (FPCB), as its name implies, is a printed circuit board manufactured using an underlying substrate that is naturally flexible. For example, a typical FPCB is manufactured using a polyimide material having one or more layers of copper disposed thereon. FPCBs are advantageous in that they can be placed in a variety of locations in which, for example, a rigid circuit board may not be as aesthetically pleasing. These FPCBs are also advantageous in that they may be virtually transparent, enabling their integration on a variety of surfaces in which transparent or translucent substrates may be advantageous. However, multi-antenna systems that utilize FPCBs have proven difficult to implement due to, inter alia, the requirement that each of the antenna elements be mounted on a single plane (i.e., coplanar) leading to, for example, insufficient isolation with other antenna elements of the multi-antenna design.

Accordingly, new techniques are needed that address these new paradigms for incorporation of these multi-antenna systems into a wider array of aesthetically pleasing applications including, for example, the aforementioned coplanar FPCBs.

### SUMMARY

The present disclosure satisfies the foregoing needs by providing, inter alia, methods, apparatus and systems for the implementation of multi-antenna systems on FPCB substrates that address the deficiencies recognized above.

In one aspect, a multi-antenna system is disclosed. In one embodiment, the multi-antenna system includes a flexible substrate having: a coplanar extended ground plane; a first slotted antenna element having a first feed structure connected with a first coplanar wave guide, the first feed structure being surrounded by the coplanar extended ground plane; and a second slotted antenna element having a second feed structure connected with a second coplanar wave guide, the second feed structure being surrounded by the coplanar extended ground plane.

In one variant, the flexible substrate further includes an isolation enhancing slot that is positioned between portions of the first slotted antenna element and portions of the second slotted antenna element.

In another variant, portions of the isolation enhancing slot are surrounded by the coplanar extended ground plane.

In yet another variant, the first feed structure has a rectangular shape having a right-side, a left-side, a top-side, and a bottom-side.

In yet another variant, a respective gap is present between the right-side, the left-side, the top-side, and the bottom-side of the first feed structure and the coplanar extended ground plane.

In yet another variant, the gap between the right-side of the first feed structure and the coplanar extended ground plane is larger in dimension than the gap between the top-side of the first feed structure and the coplanar extended ground plane.

In yet another variant, the gap between the top-side of the first feed structure and the coplanar extended ground plane is larger in dimension than the gap between the left-side of the first feed structure and the coplanar extended ground plane.

In yet another variant, the gap between the left-side of the first feed structure and the coplanar extended ground plane is larger in dimension than the gap between the bottom-side of the first feed structure and the coplanar extended ground plane.

In yet another variant, the multi-antenna system also includes a connection structure assembly, the first slotted antenna element being disposed between the connection structure and the second slotted antenna element.

In yet another variant, the second feed structure includes a rectangular shape having a right-side, a left-side, a top-side, and a bottom-side.

In yet another variant, a respective gap is present between the right-side, the left-side, the top-side, and the bottom-side of the second feed structure and the coplanar extended ground plane.

In yet another variant, the gap between the top-side of the second feed structure and the coplanar extended ground plane is larger in dimension than the gap between the bottom-side of the second feed structure and the coplanar extended ground plane.

In yet another variant, the gap between the bottom-side of the second feed structure and the coplanar extended ground plane is larger in dimension than the gap between the right-side of the second feed structure and the coplanar extended ground plane.

In yet another variant, the gap between the right-side of the second feed structure and the coplanar extended ground plane is larger in dimension than the gap between the left-side of the second feed structure and the coplanar extended ground plane.

In yet another variant, the multi-antenna system also includes a third slotted antenna element having a third feed structure connected with a third coplanar wave guide, the third feed structure being surrounded by the coplanar extended ground plane.

In yet another variant, the third slotted antenna element is disposed to the left of both the first slotted antenna element and the second slotted antenna element.

In yet another variant, the multi-antenna system also includes a fourth non-slotted antenna element having a fourth co-planar wave guide, the fourth non-slotted antenna element being larger in dimension than each of the first slotted antenna element, the second slotted antenna element, and the third slotted antenna element.

In yet another variant, the multi-antenna system also includes a stair casing feature that is implemented adjacent the fourth co-planar wave guide.

In yet another variant, the multi-antenna system also includes a connection structure assembly, the connection structure assembly having a rigid or semi-rigid printed circuit board, the connection structure assembly further comprising a connection interface that connects the rigid or semi-rigid circuit board to the flexible substrate.

In yet another variant, the connection structure assembly includes: a first coaxial cable that is connected with the rigid or semi-rigid circuit board, the first coaxial cable being in signal communication with the first coplanar wave guide; and a second coaxial cable that is connected with the rigid or semi-rigid circuit board, the second coaxial cable being in signal communication with the second coplanar wave guide.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1A is a perspective view of an exemplary multi-antenna system with slotted antenna elements and extended ground plane, in accordance with the principles of the present disclosure.

FIG. 1B is a front plan view of the exemplary multi-antenna system with slotted antenna elements and extended ground plane of FIG. 1A, in accordance with the principles of the present disclosure.

FIG. 1C is a detailed front plan view of the exemplary multi-antenna system with slotted antenna elements and extended ground plane of FIG. 1A, in accordance with the principles of the present disclosure.

FIG. 1D is a detailed front plan view of an exemplary antenna element of the first exemplary multi-antenna system with slotted antenna elements and extended ground plane of FIG. 1A, in accordance with the principles of the present disclosure.

FIG. 1E is a perspective view of the connection structure assembly for the first exemplary multi-antenna system with slotted antenna elements and extended ground plane of FIG. 1A, in accordance with the principles of the present disclosure.

All FIGURES disclosed herein are @ Copyright 2024 Taoglas Group Holdings Limited. All rights reserved.

### DETAILED DESCRIPTION

Detailed descriptions of the various embodiments and variants of the apparatus and methods of the present disclosure are now provided. It is noted that wherever practicable similar or like reference numbers may be used in the figures and may indicate similar or like functionality. The FIGURES depict an embodiment of a multi-antenna system with slotted antenna elements and extended ground plane for purposes of illustration only. One skilled in the art will readily recognize from the following description that alternative embodiments of the structures and methods illustrated herein may be employed without necessarily departing from the principles described herein.

For example, while various features discussed herein are primarily described in terms of a given frame of reference (e.g., top, bottom, left, and right, each from a preestablished reference frame), it would be readily apparent to one of ordinary skill given the contents of the present disclosure that this chosen frame of reference is arbitrary and other suitable descriptions in alternative frames of reference may be chosen to describe the various features of the multi-antenna system with slotted antenna elements and extended ground plane described herein.

Additionally, while exemplary antenna artwork for a multi-antenna system with slotted antenna elements and extended ground plane is shown herein in a specific orientation, it would be readily apparent to one of ordinary skill that the artwork shown herein may be reversed and/or rearranged in alternative implementations without departing from the principles described herein.

Moreover, while primarily discussed in terms of specific antenna operating scenarios (e.g., cellular (e.g., 2G/3G/4G/5G communication standards), global navigation satellite system (GNSS), Wi-Fi, television (TV), amplitude modulation/frequency modulation (AM/FM) radio frequency operating scenarios), it would be readily apparent to one of ordinary skill given the contents of the present disclosure that the techniques described herein may be bodily incorporated into other antenna operating scenarios outside of these specific communication protocols and operating frequency bands.

Finally, while a specific multi-antenna system with slotted antenna elements and extended ground plane embodiment is illustrated that incorporates six (6) slotted antenna elements and a total of seven (7) different antenna elements, it would be readily apparent to one of ordinary skill given the contents of the present disclosure that antenna systems that incorporate fewer slotted antenna elements (i.e., two (2) to five (5) slotted antenna elements) or more slotted antenna elements (i.e., seven (7) or more) would be enabled given the contents of the present disclosure. These and other variants would be readily appreciated by one of ordinary skill in the art, given the contents of the present disclosure.

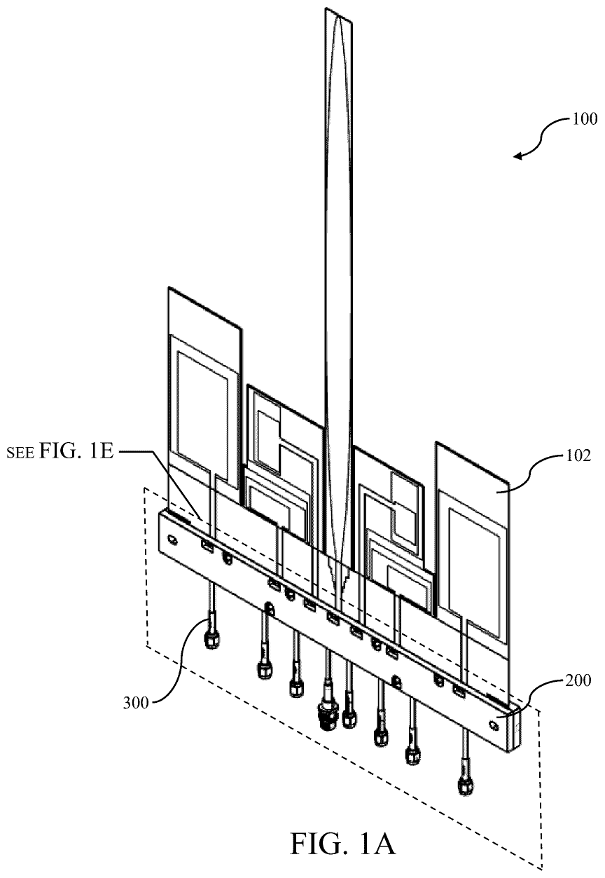

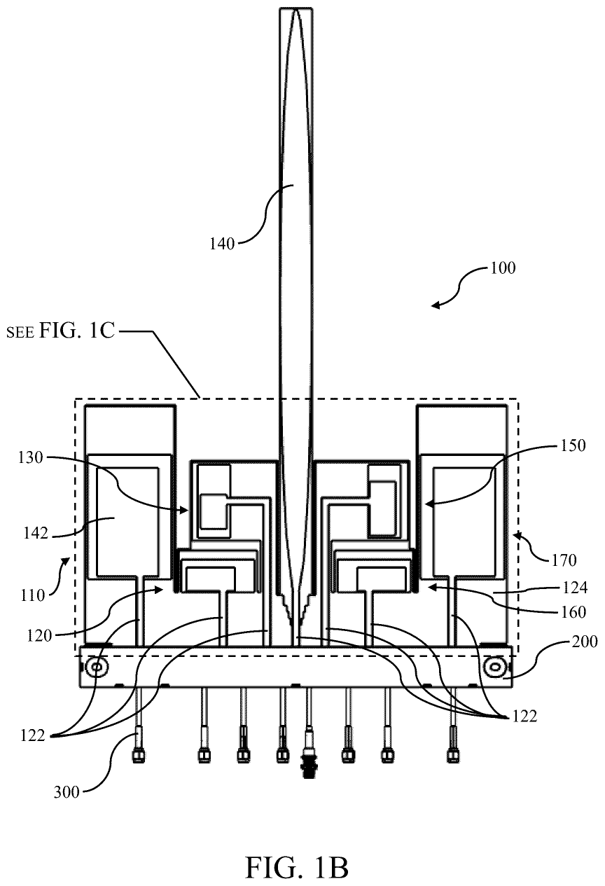

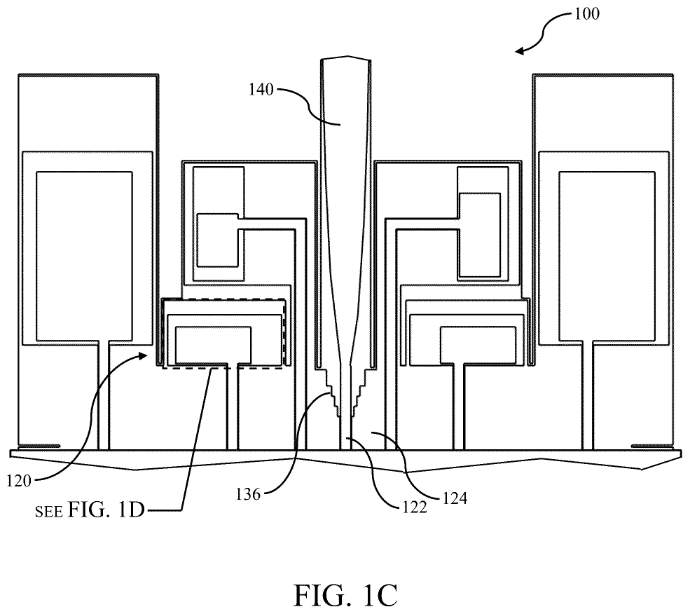

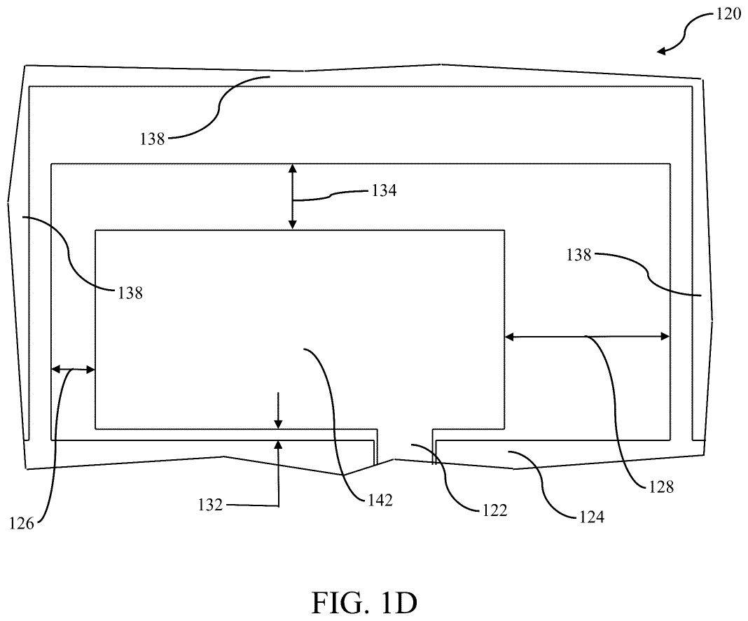

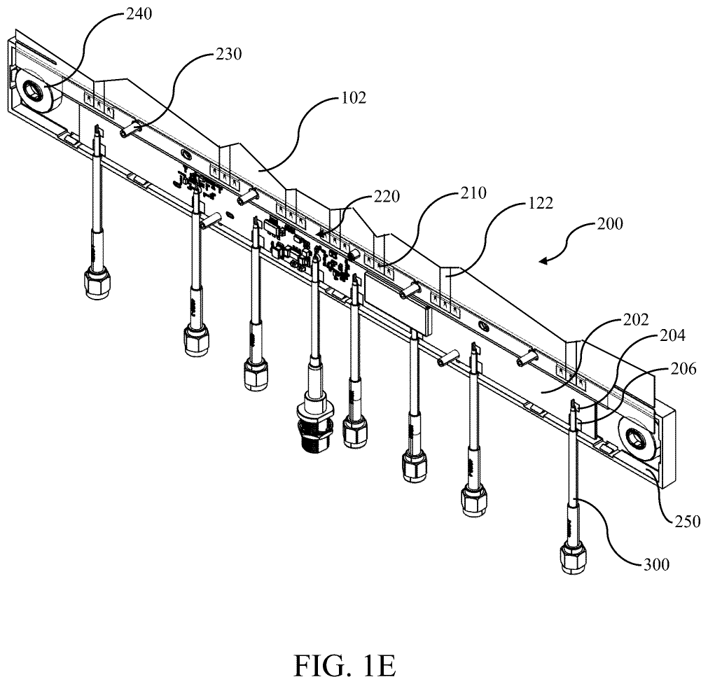

Referring now to FIG. 1A, a perspective view of an exemplary multi-antenna system with slotted antenna elements and extended ground plane 100 (“multi-antenna system”) is shown and described in detail. In some implementations, the multi-antenna system 100 may be constructed from a flexible printed circuit board (FPCB) material 102. For example, the FPCB 102 may include a copper mesh material that is attached to (or embedded within) a polyethylene terephthalate (PET) substrate. In some implementations, the FPCB material 102 may be transparent or translucent. While the use of FPCB's may be advantageous for incorporation onto various three-dimensional (3D) structures (e.g., an RV skylight), it would be readily apparent to one of ordinary skill given the contents of the present disclosure that the multi-antenna system 100 may be incorporated onto rigid or semi-rigid substrates (e.g., fiberglass materials such as FR-4 or ceramics) in alternative implementations. The multi-antenna system 100 may also include a connection structure assembly 200 which acts as an interface between individual ones of the slotted antenna elements (or antenna elements, generally) and respective input/output (I/O) cables 300. These I/O cables 300 may include coaxial-style cables in some implementations, although coaxial-style connectors (e.g., without cables) could be implemented in alternative implementations.

Referring now to FIG. 1B, a front plan view of the multi-antenna system 100 in which the various antenna elements 110, 120, 130, 140, 150, 160, 170 are incorporated within, for example, one or more extended ground planes 124. As used herein, the term “extended ground plane” means a ground plane structure that surrounds two (2) or more antenna feed structures. As shown in FIG. 1B, the multi-antenna system 100 includes a single extended ground plane 124, although it would be appreciated that this extended ground plane 124 may be divided up amongst the slotted antenna elements such that two or more slotted antenna elements may be associated with a single extended ground plane 124. For example, the left-hand side slotted antenna elements 110, 120, 130 may share a single extended ground plane 124, while the right-hand side slotted antenna elements 150, 160, 170 may share a second distinct extended ground plane 124 in some implementations. As illustrated, the multi-antenna system 100 includes seven (7) distinct antenna elements, namely a first slotted antenna element 110, a second slotted antenna element 120, a third slotted antenna element 130, a fourth (non-slotted) antenna element 140, a fifth slotted antenna element 150, a sixth slotted antenna element 160, and a seventh slotted antenna element 170. As illustrated in FIG. 1B, six (6) of these slotted antenna elements 110, 120, 130, 150, 160, 170 utilize designs where these slotted antenna elements 110, 120, 130, 150, 160, 170 utilize a conductive feed structure 142 that is almost entirely surrounded by portions of the extended ground plane 124. By utilizing such a design, individual ones of these slotted antenna elements 110, 120, 130, 150, 160, 170 maintain good isolation performance even when in close proximity to other ones of these (slotted or otherwise) antenna elements 110, 120, 130, 140, 150, 160, 170. The larger sizes of these slotted antenna elements 110, 120, 130, 150, 160, 170 are used for lower frequency bands, while the smaller sizes of these slotted antenna elements 110, 120, 130, 150, 160, 170 are used for higher frequency bands. The feed conductor 142 size (as well as the positioning within the extended ground plane 124) may be adjusted to change the impedance and broadband frequency characteristics for each of these slotted antenna elements 110, 120, 130, 150, 160, 170. The shape of each of the illustrated antenna elements 110, 120, 130, 140, 150, 160, 170 may be convex in shape (as illustrated in FIGS. 1A-1D), meaning that a line segment between any two points on the periphery of a given feed structure 142 is maintained entirely within the volume of that given feed structure 142, except for the respective coplanar wave guides 122. However, such shapes may not necessarily need to be convex in some implementations, with portions (or all) of the antenna elements 110, 120, 130, 140, 150, 160, 170 being convex, and/or non-polygon shapes.

The center antenna element 140 may behave as a wideband monopole, acting as a traveling-wave element at smaller wavelengths such as, for example, broadcast FM frequencies. An ungrounded coplanar waveguide (CPW) 122 is used to connect between the I/O connection at the connection structure assembly 200 and various ones of the antenna elements 110, 120, 130, 140, 150, 160, 170. The use of the ungrounded CPW 122 may be particularly advantageous when using a single layer of metal for the multi-antenna system 100. Referring now to FIG. 1C, various features associated with the fourth antenna element 140 are shown and described in detail. Specifically, a staircasing feature 136 may be implemented adjacent to the coplanar wave guide 122 for the fourth antenna element 140. This staircasing feature 136 may offer a “stepped impedance” like structure for the fourth antenna element 140, which may offer better impedance matching between the fourth antenna element 140 and its associated coplanar wave guide 122 (and/or I/O cable 300) that functions in conjunction with the fourth antenna element 140. The fourth antenna element 140 may also be larger in size than any of the other slotted antenna elements 110, 120, 130, 150, 160, 170 enabling the fourth antenna element 140 to operate at lower frequencies (e.g., broadcast FM frequencies) than other ones of the antenna elements 110, 120, 130, 150, 160, 170. The fourth antenna element 140 may also include a curved external profile.

Referring now to FIG. 1D, a detailed front plan view of the second slotted antenna element 120 is shown and described in detail. As a brief aside, the second slotted antenna element 120 is known as a feed in slot structure. This feed in slot structure is a common trait between the first slotted antenna element 110, the second slotted antenna element 120, the third slotted antenna element 130, the fifth slotted antenna element 150, the sixth slotted antenna element 160, and the seventh slotted antenna element 170. The feed in slot structure means that an antenna feed structure 142 is positioned such that it is surrounded by the extended ground plane 124. As previously described, the antenna feed structure 142 size (e.g., length and width, area, etc.) may be adjusted for a particular broadband frequency (e.g., cellular, Wi-Fi, GNSS, etc.), while the positioning of the gaps 126, 128, 132, 134 between the feed structure 142 itself and the extended ground plane 124 can be used to adjust, for example, the impedance characteristics of a given feed in slot structure. As shown in FIG. 1D, an isolation enhancing slot 138 is positioned external to the extended ground plane 124 of the second slotted antenna element 120. As a brief aside, the isolation enhancing slot 138 is shown and described with reference to FIG. 1D for purposes of clarity only; however, these isolation enhancing slots 138 are present between most (if not all) of the antenna elements 110, 120, 130, 140, 150, 160, 170. These isolation enhancing slots 138 are beneficial in that the slots in the extended ground plane 124 surrounding the slotted antenna elements enhance isolation by creating currents with opposing phases, which cancel each other out.

Referring to the specific positioning associated with the second slotted antenna component 120, the feed in slot structure for the second slotted antenna component 120 has a left gap width 126, a right gap width 128, a bottom gap width 132, and a top gap width 134. The sizing for the gap widths is smallest for the bottom gap width 132 and largest for the right gap width 128. The left gap width 126 is larger than the bottom gap width 132, but smaller than the top gap width 134. The top gap width 134 is smaller than the right gap width 128, but larger than both the left gap width 126 and the bottom gap width 132. Variations between the sizing of the left gap width 126, the right gap width 128, the bottom gap width 132, and the top gap width 134 may be implemented for each of the other feed in slot structures, namely the first slotted antenna element 110, the third slotted antenna element 130, the fifth slotted antenna element 150, the sixth slotted antenna element 160, and the seventh slotted antenna element 170.

Referring now to FIG. 1E, various features of the connection structure assembly 200 are shown and described in detail. Specifically, the connection structure assembly 200 may include a front and a back housing 250 (the back housing only being visible in FIG. 1E). A rigid or semi-rigid substrate 202 is mounted within the housings 250 of the connection structure assembly 200. Various boss features 230 are located within the housings 250 which are utilized for alignment of the antenna substrate 102 with the rigid or semi-rigid substrate 202. Various features (not shown) may also be incorporated within one or more of the housings 250 to ensure an even amount of pressure is applied throughout the length of the rigid or semi-rigid substrate 202. The rigid or semi-rigid substrate 202 may also include an I/O cable feed connection 204 and an I/O cable ground connection 206 for each of the I/O cables 300. Spring contacts 210 may be utilized for the interface between the rigid or semi-rigid substrate 202 and the antenna substrate 102, although alternative connection methodologies such as, for example, pogo pins, solder connections, etc., may be substituted in some implementations. As shown, each antenna element 110, 120, 130, 140, 150, 160, 170 may be connected with the rigid or semi-rigid substrate 202 via three spring contacts 210. These three spring contacts 210 may include a single feed connection to the respective coplanar wave guide 122 and two ground connections to the extended ground plane 124. The rigid or semi-rigid substrate 202 may also include electronic circuitry 220 disposed thereon. This electronic circuitry 220 may include filtering circuitry and/or amplification circuitry for some (or all) of the antenna elements. An optional threaded fastener mount 240 may be utilized to secure the front housing to the back housing and/or to secure the multi-antenna system to the mounting surface for the desired implementation. Alternative implementations may utilize snap fits, rivets, and/or adhesives in addition to, or alternatively than, the threaded fastener mount 240 illustrated.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. A multi-antenna system, comprising:
a flexible substrate comprising:
a coplanar extended ground plane;
a first slotted antenna element comprising a first feed structure connected with a first coplanar wave guide, the first feed structure being surrounded by the coplanar extended ground plane; and
a second slotted antenna element comprising a second feed structure connected with a second coplanar wave guide, the second feed structure being surrounded by the coplanar extended ground plane.

2. The multi-antenna system of claim 1, wherein the flexible substrate further comprises an isolation enhancing slot that is positioned between portions of the first slotted antenna element and portions of the second slotted antenna element.

3. The multi-antenna system of claim 2, wherein portions of the isolation enhancing slot are surrounded by the coplanar extended ground plane.

4. The multi-antenna system of claim 1, wherein the first feed structure comprises a rectangular shape having a right-side, a left-side, a top-side, and a bottom-side.

5. The multi-antenna system of claim 4, wherein a respective gap is present between the right-side, the left-side, the top-side, and the bottom-side of the first feed structure and the coplanar extended ground plane.

6. The multi-antenna system of claim 5, wherein the gap between the right-side of the first feed structure and the coplanar extended ground plane is larger in dimension than the gap between the top-side of the first feed structure and the coplanar extended ground plane.

7. The multi-antenna system of claim 6, wherein the gap between the top-side of the first feed structure and the coplanar extended ground plane is larger in dimension than the gap between the left-side of the first feed structure and the coplanar extended ground plane.

8. The multi-antenna system of claim 7, wherein the gap between the left-side of the first feed structure and the coplanar extended ground plane is larger in dimension than the gap between the bottom-side of the first feed structure and the coplanar extended ground plane.

9. The multi-antenna system of claim 1, further comprising a connection structure assembly, the first slotted antenna element being disposed between the connection structure and the second slotted antenna element.

10. The multi-antenna system of claim 9, wherein the second feed structure comprises a rectangular shape having a right-side, a left-side, a top-side, and a bottom-side.

11. The multi-antenna system of claim 10, wherein a respective gap is present between the right-side, the left-side, the top-side, and the bottom-side of the second feed structure and the coplanar extended ground plane.

12. The multi-antenna system of claim 11, wherein the gap between the top-side of the second feed structure and the coplanar extended ground plane is larger in dimension than the gap between the bottom-side of the second feed structure and the coplanar extended ground plane.

13. The multi-antenna system of claim 12, wherein the gap between the bottom-side of the second feed structure and the coplanar extended ground plane is larger in dimension than the gap between the right-side of the second feed structure and the coplanar extended ground plane.

14. The multi-antenna system of claim 13, wherein the gap between the right-side of the second feed structure and the coplanar extended ground plane is larger in dimension than the gap between the left-side of the second feed structure and the coplanar extended ground plane.

15. The multi-antenna system of claim 1, further comprising a third slotted antenna element comprising a third feed structure connected with a third coplanar wave guide, the third feed structure being surrounded by the coplanar extended ground plane.

16. The multi-antenna system of claim 15, wherein the third slotted antenna element is disposed to the left of both the first slotted antenna element and the second slotted antenna element.

17. The multi-antenna system of claim 16, further comprising a fourth non-slotted antenna element comprising a fourth co-planar wave guide, the fourth non-slotted antenna element being larger in dimension than each of the first slotted antenna element, the second slotted antenna element, and the third slotted antenna element.

18. The multi-antenna system of claim 17, further comprising a stair casing feature that is implemented adjacent the fourth co-planar wave guide.

19. The multi-antenna system of claim 1, further comprising a connection structure assembly, the connection structure assembly further comprising a rigid or semi-rigid printed circuit board, the connection structure assembly further comprising a connection interface that connects the rigid or semi-rigid circuit board to the flexible substrate.

20. The multi-antenna system of claim 19, wherein the connection structure assembly further comprises:
a first coaxial cable that is connected with the rigid or semi-rigid circuit board, the first coaxial cable being in signal communication with the first coplanar wave guide; and
a second coaxial cable that is connected with the rigid or semi-rigid circuit board, the second coaxial cable being in signal communication with the second coplanar wave guide.
